(19) United States
(12) Patent Application Publication
(10) Pub. No.: US 2010/0003879 A1
(43) Pub. Date: Jan. 7, 2010

(54) Composition ignifugee a base de PVC

(75) Inventor: Isabelle Conesa, Saint Romain De Jalionas (FR)

Correspondence Address: OLIFF & BERRIDGE, PLC, P.O. BOX 320850, ALEXANDRIA, VA, 22320-4850, US

(73) Assignee: PORCHER INDUSTRIES, BADINIERES (FR)

(21) Appl. No.: 12/458,185

(22) Filed: Jul. 2, 2009

Related U.S. Application Data
(60) Provisional application No. 61/129,536, filed on Jul. 2, 2008.

(51) Int. Cl. B32B 27/12; C08K 3/10; C08K 5/11; C08K 5/12; C08K 5/101; C08K 5/51; C08K 3/38; C08K 3/22; D02G 1/02

(52) U.S. Cl. 442/136; 524/434; 524/315; 524/296; 524/287; 524/147; 524/404; 524/437; 524/433; 57/257; 57/296

(57) ABSTRACT

The use for yarn coating, for the manufacture of sun canopies, of a flame-retardant plastisol including a chlorinated polymer material free of lead including at least:
from 15 to 60% of a chlorinated polymer material,
from 10 to 30% of a non polymer plasticizer free of orthophtalate,
a flame-retardant filler free of antimony comprising of 2 to 15% metal hydrate and/or 5 to 30% of zinc salt,

the percentages being calculated with respect to the total weight of the plastisol.

The flame-retardant plastisol including a chlorinated polymer material free of lead including at least:
from 15 to 60% of a chlorinated polymer material,
from 10 to 30% of a polymer plasticizer free of orthophtalate,
a flame-retardant filler free of antimony comprising of 2 to 15% metal hydrate and/or 5 to 30% of zinc salt,

the percentages being calculated with respect to the total weight of the plastisol.

The present invention relates to a flame-retardant composition based on PVC plastisol included in the composition of technical textile structures that may be used in the construction industry, and to its application, inter alia, for the manufacture of yarns for weaving sun canopies.

Such textiles are subject to national or international approval regulations and/or procedures defining their fire behaviour both in terms of flammability and in terms of smoke emission, this fire behaviour being directly dependent on their organic matter content.

Technical yarns are made of a core comprising a continuous yarn, especially made of an inorganic material such as glass, or an organic material such as polyamide or polyvinyl alcohol, and a sheath or envelope comprising a matrix, made of at least one polymer material, a flame-retardant mineral filler incorporated into and distributed in the matrix, and a plasticizer. Such yarns are obtained by coating the core with one or two coats of a plastisol comprising the polymer material, the flame-retardant mineral filler and the plasticizer, followed by gelling the plastisol around the core.

Often, the polymer of which the matrix is made is a chlorinated polymer material, for example a polyvinyl chloride (PVC).

Many solutions have been proposed for improving the fire behaviour of matrices into which a flame-retardant filler is incorporated.

Thus, for example, JP-A-58 18 56 37, for a matrix based on PVC and polyethylene chloride for the manufacture of cables, discloses a flame-retardant filler comprising a compound chosen from antimony and aluminium oxides and/or hydroxides and preferentially another compound chosen from zinc salts including zinc borate, and tin-based products, for instance tin stannate.

Also, FR 2 448 554 discloses a PVC-based matrix for coating cables, incorporating a stabilizer and a plasticizer made of a phosphoric ether, an alumina hydroxide filler and an additional flame-retardant filler composed of antimony oxides optionally combined with a zinc borate.

Also, U.S. Pat. No. 6,087,428 discloses PVC-based compositions for manufacturing insulating materials for cable, characterized in that they comprise a polymer plasticizer, magnesium carbonate, aluminium trihydrate and zinc hydroxystannate and optionally antimony trioxide. It is mentioned that the flame retardant properties of the PVC composition are improved by the addition of antimony trioxide, the example of implementation of this patent comprises essentially antimony trioxide. This document does not disclose to perform flame-retardant composition having good flame-retardant properties without the addition of antimony.

EP 900 294 discloses a yarn whose sheath is made of a PVC-based matrix whose flame-retardant filler comprises a ternary composition combining an antimony oxide and a hydrated metal oxide. The PVC of which the said matrix is made further comprises a plasticizer comprising at least one organic orthophthalate.

Finally, WO91/01348 discloses a flame-retardant polymer formulation comprising a synergic combination of flame-retardant agent comprising magnesium or aluminium hydroxide and a tin oxide or a stannate or hydroxystannate. This formulation comprises an orthophtalate plasticizer (reomol DOP).

These compositions are particularly efficient as regards to their fire behaviour, but antimony may comprise traces of heavy metals such as lead, and antimony trioxide is classified in category 3 in Europe as a substance that is hazardous to man on account of possible carcinogenic effects (JOCE, 1994).

PVC is also widely criticized on account of the use of phthalate plasticizers conventionally included in its composition in order to improve its mechanical characteristics (suppleness). On ageing under the effect of ultraviolet radiation, these phthalates migrate to the surface of supple PVC articles and may become a source of contamination.

U.S. Pat. No. 5,227,417 discloses compositions comprising a PVC resin, at least one plasticizer, at least a flame-retardant agent, at least two smoke suppressants which interact synergically and a heat stabilizer. The plasticizer is at least one double component plasticizer system, the first plasticizer is a phosphate ester based plasticizer, the second plasticizer is a brominated aromatic ester plasticizer. The flame-retardant agent is an alumina trihydrate, the smoke suppressant system is a mixture of ammonium octamolybdate and a zinc compound (molybdate, borate, oxide, phosphate . . . ) and the heat stabilizer is a lead based heat stabilizer. This composition comprises toxic heavy metals (lead).

This patent also comprises examples (4 and 8) in which the composition does not comprise phosphate plasticizers, however table in column 4 shows that those formulations does not give as good result, especially the oxygen index is not as important as the formulations comprising a mixture of phosphate and phthalate plasticizers. Moreover, those formulations contain toxic lead salts.

Finally U.S. Pat. No. 4,272,427 discloses a composition comprising a phosphate and/or phtalate plasticizer and smoke suppressants such as zinc carbonate and magnesium carbonate. This composition does not comprise flame-retardant agent.

It is thus important to find alternatives to the use of antimony and lead and to reduce, or even dispense with altogether, orthophthalates in PVC-based compositions, while nonetheless maintaining the fire behaviour properties and also the Theological properties.
One of the objects of the invention is a flame-retardant plastisol comprising a chlorinated polymer material free of leadcharacterized in that it comprises at least:from 15 to 60% of a chlorinated polymer material,
from 10 to 30% of a plasticizer consisting of one or a mixture of a non polymer plasticizer free of orthophtalate,
a flame-retardant filler free of antimony consisting of 2 to 15% metal hydrate and/or 5 to 30% of zinc salt,
   the percentages being calculated with respect to the total weight of the plastisol.

In another embodiment the invention relates to a flame-retardant plastisol free of orthophtalate, free of antimony and free of lead, characterized in that it comprises at least:
from 15 to 60% of a chlorinated polymer material,
from 10 to 30% of a plasticizer consisting of one or a mixture of a non polymer plasticizer,
a flame-retardant filler consisting of 2 to 15% metal hydrate and/or 5 to 30% zinc salt,
   the percentages being calculated with respect to the total weight of the plastisol.

In accordance with the invention, any PVC resin capable of being plasticized, and, in particular, consequently capable of being used in plastisol form, may be used as chlorinated material.

The term “chlorinated polymer material” means either a pure chlorinated polymer or a copolymer of vinyl chloride copolymerized with other monomers, or alternatively a chlorinated polymer that is combined with other polymers.

Among the monomers that may be copolymerized with vinyl chloride, mention will be made especially of olefins, for instance ethylene, vinyl esters, saturated carboxylic acids, for instance vinyl acetate, vinyl butyrate or maleates, halogenated vinyl derivatives, for instance vinylidene chloride, or acrylic or methacrylic acid esters, for instance butyl acrylate.

Examples of chlorinated polymers that will be mentioned include polyvinyl chloride, and also superchlorinated PVCs, polyvinylidene chlorides and chlorinated polyolefins.

In one embodiment, the chlorinated polymer material according to the present invention has a halogen weight content of between 40% and 70%.

The term “polymer plasticizer” means a plasticizer which is initially under the form of a polymer.

The term “antimony” means any antimony salt and more particularly antimony oxides and hydroxides.

The term “lead” means any lead salt and more particularly lead salts used as heat stabilizer for instance lead sulphate.

The term “phthalate” means esters of the ortho isomeric form of benzenedicarboxylic acid, phthalic acid, this name not being applicable to the meta and para isomers of benzenedicarboxylic acid. This ortho isomeric form is metabolized into monoester, which is responsible for the toxicological processes observed in living organisms. The other isomers of the benzenedicarboxylic acid esters (metaand para) are not metabolized into monoester and therefore have no toxicological activity. The meta- and paraphtalate can thus be used without toxicological risks in plastisol formulations.

The invention also relates to the said plastisol, characterized in that the plasticizer is chosen from the group formed by aliphatic dicarboxylic acid esters, 1,4-benzenedicarboxylic acid esters, benzoates, phosphates, trimellitates and meta and/or paraphtalate (terephtalate), alone or as a mixture.

In one embodiment the plastisol is characterized in that the plasticizer is chosen in the group formed by aliphatic dicarboxylic acid esters.

In one embodiment, the aliphatic dicarboxylic acid esters are chosen from cyclooctyl dicarboxylic esters and especially diisononyl-1,2-cyclohexanedicarboxylate and its derivatives, adipic acid esters and especially bis(2-ethylhexyl)adipate, citric acid esters and especially tris(2-ethylhexyl)citrate, esters of sebacate type, for instance bis(2-ethylhexyl)sebacate, and azelates, for instance bis(2-ethylhexyl)azelate

In one embodiment, the plastisol is characterized in that the plasticizer agent is chosen in the group formed by 1,4-benzenedicarboxylic acid esters.

In one embodiment 1,4-benzenedicarboxylic acid esters are chosen in the group formed by 1,4-benzenedicarboxylic acid esters, such as bis(2-ethylhexyl) 1,4-benzenedicarboxylate.

In one embodiment the plastisol is characterized in that the plasticizer is chosen in the group of benzoates.

In one embodiment the benzoates are chosen from the group formed by dipropylene glycol dibenzoate, diethylene glycol dibenzoate, ethyl hexylmonobenzoate, texanol benzoate, glycol benzoate and propylene glycol dibenzoate.

In one embodiment the plastisol is characterized in that the plasticizer is chosen in the group of phosphate.

In one embodiment, the phosphates are chosen from the group formed by 2-ethylhexyl diphenyl phosphate, isodecyl diphenyl phosphate, the mixture of dodecyl and tetradecyl diphenyl phosphate, trioctyl phosphate, tributyl phosphate, butylphenyl diphenyl phosphate and isopropyl triphenyl phosphate.

In one embodiment the plastisol is characterized in that the plasticizer is chosen in the group of trimellitates.

In one embodiment, the trimellitates are chosen from the group formed by trioctyl trimellitate, tris(2-ethylhexyl)trimellitate and tri(heptyl, nonyl)trimellitate.

In one embodiment the plastisol is characterized in that the plasticizer is chosen in the group of meta and/or paraphtalate.

In one embodiment the plastisol is characterized in that the plasticizer is selected in the group formed by bis(2-ethylhexyl)-1,4-benzendicarboxylate (e.g.: Eastman 168 from EASTMAN), dipropylene glycoldibenzoate (e.g: BENZOFLEX from VELSICOL CHEMICAL CORPORATION), diisononyl-1,2-cyclohexanedicarboxylate (e.g: HEXAMOLL DINCH from BASF), di-(2ethylhexyl)-adipate (e.g: PLASTOMOLL DOA from BASF), 2-ethylhexyl diphenyl phosphate (e.g: SANTICIZER 141 de FERRO), le trioctyl trimellitate (e.g: PALATINOL TOTM de BASF) and a cyclohexancarboxylic acid (e.g: DHIN from CALDIC), alone or as a mixture.

In one embodiment the plastisol is characterized in that the plasticizer is a mixture of terephtalates and phosphate plasticizer.

In one embodiment the plastisol is characterized in that the plasticizer is a mixture of aliphatic dicarboxylic acid esters and a phosphate plasticizer. In one embodiment the plastisol is characterized in that the plasticizer is a mixtrure of a cyclohexancarboxylic acid (e.g DHIN from Caldic) and a phosphate-based plasticizer.

In one embodiment the plastisol is characterized in that the plasticizer is a mixtue of bis(2-ethylhexyl)-1,4-benzendicarboxylate (e.g Eastman 168 de Eastman).

In one embodiment the plastisol is characterized in that the plasticizer is a mixtrure of a cyclohexancarboxylic acid (e.g DHIN from Caldic) and 2-ethylhexyl diphenyl phosphate (e.g Santicizer 141 from Ferro).

In one embodiment the plastisol is characterized in that the plasticizer is 2-ethylhexyl diphenyl phosphate (e.g Santicizer 141 from Ferro).

In one embodiment the plastisol is characterized in that the plasticizer is diisononyl-1,2-cyclohexanedicarboxylate (e.g Hexamoll DINCH from BASF).

In one embodiment of the invention the metal hydrate is chosen from the group formed by hydrated aluminium, boron, zinc, tin and magnesium salts, alone or as mixtures.

In one embodiment of the invention the metal hydrate is chosen from the group formed by hydrated aluminium, boron, tin and magnesium salts, alone or as mixtures.

In one embodiment, the hydrated aluminium, boron, zinc, tin and magnesium salts are chosen from the group formed by alumina trihydrate, hydrated zinc borate, zinc hydroxystannate and magnesium hydroxide.

In one embodiment the metal hydrate is chosen in the group formed by the trihydrate and the magnesium hydroxide, alone or as a mixture.

In one embodiment the metal hydrate is a alumina trihydrate.

In one embodiment the metal hydrate is a magnesium hydroxide.

In one embodiment the zinc salts are chosen from hydrated or non-hydrated salts, alone or as a mixture.

In one embodiment, the zinc salts are chosen from the group formed by zinc stannate, zinc hydroxystannate and zinc borate.

In one embodiment according to the invention, the weight ratio between the metal hydrate and the zinc salt is about 2:7 and preferably 1:3.

In one embodiment, the plastisol further comprises at least one dispersant or wefting agent.

The purpose of the wefting agents or dispersants is to facilitate the incorporation of the fillers into the PVC compositions. Among the dispersants or wetting agents that may be mentioned are highly volatile medium-chain aliphatic hydrocarbons, mixtures of carboxylic acid esters and dispersant compounds, and polar esters of long-chain alcohols, such as those sold by the company BYK Chemie.

In one embodiment according to the invention, the plastisol further comprises at least one ultraviolet absorber or stabilizer. Examples of absorbers or stabilizers that may be mentioned include benzotriazoles and benzophenones.

In another embodiment according to the invention, the plastisol may further comprise an opacifier, for example based on titanium dioxide or zinc sulfide.

In one embodiment according to the invention, the flame-retardant filler comprising the metal hydrate and the zinc salt may be incorporated directly into the plastisol.

In another embodiment, the flame-retardant filler may be incorporated into the plastisol in the form of a flame-retardant paste.

In this embodiment, the flame-retardant paste is made up such that it comprises the metal hydrate and the zinc salt in a weight ratio of 2:7 and preferably 1:3.

In another embodiment, the flame-retardant paste is characterized in that it further comprises a dispersant or wetting agent, as defined previously.

In another embodiment, the flame-retardant paste is characterized in that it further comprises a plasticizer, as defined previously.

In another embodiment, the flame-retardant paste is characterized in that it further comprises an ultraviolet absorber, as defined previously.

In one embodiment the flame-retardant filler of the plastisol is constituted of 2 to 15% metal hydrate and 5 to 30% zinc salt, the percentages being calculated with respect to the total weight of the plastisol, in which the flame-retardant filler is such as defined previously and in the whole embodiments.

In one embodiment the plastisol of the invention is characterized in that it is free of lead and comprises at least:
15 to 60% chlorinated polymer material,
10 to 30% plasticizer consisting of one or various non polymer material free of orthophtalate,
A flame-retardant filler constituted of 2 to 15% metal hydrate and/or 5 to 30% zinc salt,
   The percentages being calculated with respect to the total weight of the plastisol, and in which the flame-retardant filler is such as defined previously and in the whole embodiment.

In another embodiment the plastisol of the invention is a flame-retardant plastisol free of orthophtalate and free of lead characterized in that it comprises at least:
15 to 60% chlorinated polymer material,
10 to 30% non polymer plasticizer,
A flame-retardant filler constituted of 2 to 15% metal hydrate and/or 5 to 30% zinc salt,
   The percentages being calculated with respect to the total weight of the plastisol, and in which the flame-retardant filler is such as defined previously and in the whole embodiment.

Another object of the invention is a flame-retardant yarn coated with the plastisol of the present invention.

The coated flame-retardant yarn according to the invention is obtained by spinning fibres made of an organic or inorganic material or of natural fibres and of a plastisol according to the invention.

In one embodiment, the coated flame-retardant yarn is characterized in that the inorganic material of which the fibres of the yarn are made is chosen from the group formed by glass and silica.

In one embodiment, the coated flame-retardant yarn is characterized in that the organic material of which the fibres of the yarn are made is chosen from the group formed by aramid and grades of flame-retardant polyester.

The invention also relates to a process for manufacturing a flame-retardant yarn, coated according to the invention, characterized in that a continuous yarn obtained by spinning fibres made of an organic or inorganic material is subjected to a process of coating with one or two coats of a plastisol according to the invention.

Another object of the invention is a textile structure comprising at least one flame-retardant yarn coated with the plastisol according to the invention.

It also relates to a textile structure, for example a woven, characterized in that it may be obtained from at least one flame-retardant yarn coated according to the invention.

Another object of the invention is a sun blind comprising at least one textile structure manufactured from flame-retardant yarns, coated with the plastisol according to the invention.

Another object of the present invention is also the use of the textile structures thus obtained in the manufacture of sun blinds, display screens and coatings for walls or ceilings.

One of the objects of the invention is the use of such a plastisol for yarn coating, for the manufacture of sun canopies.

The examples that follow illustrate the invention.

By coating a mineral/continuous glass fibre/silicone yarn with a liquid polymer preparation based on chlorinated polymer, a coated flame-retardant yarn according to the invention is obtained.

The coating formulation is defined by a viscosity of between 500 and 10 000 mPa·s and preferably between 1000 and 5000 mPa·s, measured at 25° C. with a Brookfield RVT viscometer at 20 rpm, using a No. 4 spindle.

The coating is performed with a formulation comprising the following components:

| | | |
|---|---|---|
| PVC resin | 100 | pcr |
| extender or filler resin | 20 to 30 | pcr |
| flame-retardant paste composed of | 20 to 40 | pcr |
| tin salt and metal hydrate | | |
| orthophthalate-free plasticizer | 30 to 50 | pcr |
| additives | 10 to 30 | pcr |

The additives are, for example, diluents, wefting agents, lubricants, stabilizers or opacifiers, but also antifoams, bubble-removing agents, optical brighteners, spreading agents or even rheological agents.
For the preparation of the formulation according to the invention, the following ingredients were used, for example:

### Resins:

a—PVC resin: microsuspension or emulsion, for example Vinnolit P70,

b—filler resin: suspension-type filler such as Lacovyl PS 1050,
plasticizers: Eastman 168 from Eastman, Benzoflex from Velsicol Chemical Corporation, Hexamoll Dinch from BASF, Plastomoll DOA from BASF, Santicizer 141 from Ferro, Palatinol TOTM from BASF and DHIN from Caldic.

### Flame-Retardant Fillers:

flame retardants: alumina hydrate such as SH5 from Omya, zinc hydroxystannate from Amik or from Univar.

Formulation 1

| | Proportion (% of the total weight |
|---|---|
| Component | of the composition) |
| PVC Resin: | 45% |
| VINNOLIT P70 | |
| resin extender or filler: | 13% |
| PS 1050 | |
| Flame-retardant paste | 14% |
| Plasticizer (Eastman 168) | 19% |
| Diluent agent (EXXSOL) | 19% |
| Heat stabilizer (UBZ 171) | 6% |

The flame-retardant paste having the following composition:

| | Proportion (% of the |
|---|---|
| Component | total weight of the composition) |
| Alumina trihydrate SH5 | 18% |
| Zinc hydroxystannate | 54% |
| from UNIVAR | |
| Plasticizer (Eastman | 21% |
| 168) | |
| Wetting agent (BYK | 7% |
| Disperplast I) | |

The composition thus prepared is applied to a 68 tex silicone yarn by means of a die.

The yarns coated with the plastisol of the example comprising a 68 tex silicone core 165 tex coated were woven, and the said woven was tested as regards its fire resistance according to standard DIN 4102-2 and standard NF P 92503.

Formulation 2:

| | Proportion (% of the total |
|---|---|
| Component | weight of the composition) |
| PVC resin: | 40.6% |
| SOLVIN 372 NA | |
| Filler resin: | 17.4% |
| SOLVIN 266 SC | |
| Flame-retardant paste | 15% |
| Plasticizer (DINCH from BASF) | 20% |
| Diluent agent (ISOPAR L) | 4% |
| Heat stabilizer (Lastab S-CP | 2% |
| 816) | |

The flame-retardant past having the following composition:

| | Proportion (% of the total |
|---|---|
| Component | weight of the composition) |
| Magnesium hydroxide | 18% |
| Zinc stannate | 56% |
| Plasticizer (Eastman 168) | 21% |
| Wetting agent (Disperplast I) | 5% |

The composition thus prepared is applied to a 33 tex silicone yarn by means of a die to obtain a 97 tex.

Formulation 3

| | Proportion (% of the total |
|---|---|
| Component | weight of the composition) |
| PVC resin: | 48% |
| LACOVYL PB 1302 | |
| filler resin: | 10% |
| VINNOL C66W | |
| Flame-retardant paste | 12% |
| plasticizerDHIN from CALDIC | 14% |
| Santicizer 141 | 5% |
| Diluent agent (White spirit) | 4% |
| Heat stabilizer (Lastab CZ314) | 3% |

The falme-retardant paste having the following composition:

| | Proportion (% of the total |
|---|---|
| Component | weight of the composition) |
| Alumina Trihydrate | 18% |
| Zinc Hydroxystannate | 56% |
| Plasticizer (Eastman 168) | 21% |
| Wetting agent (Disperplast I) | 5% |

The composition thus prepared is applied to a 33 tex silicone yarn by means of a die to obtain a 115 tex.

A yarn according to the present invention may be incorporated into any textile structure, or assembled according to any required textile structure, which is two-dimensional (laps, wovens, etc.) or three-dimensional (for example braids).

The yarn may first be cut and divided into elementary yarns, which may be entangled and bonded together, in the form of nonwoven textile structures, for example mats. The bonding of the entangled elementary yarns may be obtained by impregnation with a suitable adhesive substance, or alternatively by hot-boding the polymer material of the sheath.

The yarn may then be self-assembled, in any suitable knitted textile structure, but it may also be assembled with other yarns, according to the present invention or otherwise, to constitute different two-dimensional or three-dimensional structures: in the latter case, they may be grids in which the yarns according to the present invention are interwoven and bonded with other yarns, according to the present invention or otherwise, and wovens, in which the yarns according to the invention are woven with other warp and/or weft yarns, which may also be according to the invention or otherwise.

One most particular application of the present invention concerns the production of technical fabrics, for producing or manufacturing both interior and exterior canopies or curtains.

1. Flame-retardant plastisol comprising a chlorinated polymer material free of lead comprising at least:
from 15 to 60% of a chlorinated polymer material,
from 10 to 30% of a non polymer plasticizer consisting free of orthophtalate,
a flame-retardant filler free of antimony comprising of 2 to 15% metal hydrate and/or 5 to 30% of zinc salt,
the percentages being calculated with respect to the total weight of the plastisol.

2. Plastisol according to claim 1, wherein the plasticizer is chosen in the group formed by aliphatic dicarboxylic acid esters, 1,4-benzenedicarboxylic acid esters, benzoates, trimellitates, phosphates, and meta and/or paraphtalate alone or as mixtures.

3. Plastisol according to claim 1, comprising at least:
from 15 to 60% of a chlorinated polymer material,
from 10 to 30% of a plasticizer consisting of one or a mixture of a non polymer plasticizer free of orthophtalate,
a flame-retardant filler consisting of 2 to 15% metal hydrate and/or 5 to 30% zinc salt,
the percentages being calculated with respect to the total weight of the plastisol.

4. Plastisol according to claim 1, wherein the chlorinated polymer is chosen from polyvinyl chloride, superchlorinated PVCs, polyvinylidene chlorides and chlorinated polyolefins.

5. Plastisol according to claim 1, wherein the hydrate metal is chosen from the group formed by hydrated aluminium, boron, zinc, tin and magnesium salts, alone or as mixtures.

6. Plastisol according to claim 5, wherein the hydrated aluminium, boron, zinc and tin salts are chosen from the group formed by alumina trihydrate, zinc borate, zinc hydroxystannate and magnesium hydroxide.

7. Plastisol according to claim 1, wherein the zinc salts are chosen from hydrated or non-hydrated salts, alone or as a mixture.

8. Plastisol according to claim 1, wherein the zinc salts are chosen from the group formed by zinc stannate, zinc hydroxystannate and zinc borate.

9. Plastisol according to claim 1, wherein the weight ratio between the metal hydrate and the zinc salt is about 2:7.

10. Flame-retardant yarn coated with a plastisol according to claim 1.

11. Yarn made of a continuous yarn obtained by spinning fibres, made of an organic or inorganic material or of natural fibres, and a plastisol according to claim 1.

12. Yarn according to claim 11, wherein the inorganic or organic material of which the fibres of the yarn are made is chosen from the group formed by glass and silica.

13. Process for manufacturing a yarn comprising obtaining a continuous yarn by spinning fibres made of an organic or inorganic material and subjecting the yarn to a process of coating with one or two coats of a plastisol according to claim 1.

14. Textile structure, for example a woven, wherein it may be obtained from at least one yarn according to claim 10.

15. Sun blind comprising at least one textile structure according to claim 14.

16. (canceled)
